(19) United States
(12) Patent Application Publication
(10) Pub. No.: US 2005/0126383 A1
(43) Pub. Date: Jun. 16, 2005

(54) Fluid circuit system

(75) Inventors: Shigekazu Nagai, Adachi-ku (JP); Koji Sugano, Koshigaya-shi (JP)

Correspondence Address: PAUL A. GUSS;PAUL A. GUSS ATTORNEY AT LAW, 775 S 23RD ST FIRST FLOOR SUITE 2, ARLINGTON, VA, 22202, US

(73) Assignee: SMC Kabushiki Kaisha, Tokyo (JP)

(21) Appl. No.: 11/008,190

(22) Filed: Dec. 10, 2004

(30) Foreign Application Priority Data
Dec. 11, 2003 (JP) 2003-413775

(51) Int. Cl. F01B 1/00; F15B 15/17; F02D 13/04

(52) U.S. Cl. 91/165; 91/415

(57) ABSTRACT

Heat is exchanged between high temperature compressed air yet to be supplied to air cylinders and low temperature exhaust air having already been supplied to the air cylinders and having completed its work, using a heat exchange unit arranged in a closed loop circuit. Thermal energy of the high temperature compressed air migrates to the low temperature exhaust air. Therefore, the temperature of the high temperature compressed air is lowered, while the temperature of the exhaust air is raised. The exhaust air, having been raised in temperature, is aspirated from an air aspiration port of a compressor.

### BACKGROUND OF THE INVENTION

1. Field of the Invention

The present invention relates to a fluid circuit system, which makes it possible to efficiently operate a compressor for supplying compressed air (supply gas), for example, to pneumatic actuators such as cylinders.

2. Description of the Related Art

FIG. 18 shows an air circuit that uses a conventional technique for driving a plurality of air cylinders attached to each of solenoid-operated valve manifolds.

The air circuit 1 comprises a large capacity type compressor 2, an after cooler 3, an air tank 4, a first filter 5, and an air drier 6, which are connected in series respectively. Second filters 8, pressure-reducing valves 9, pressure gauges 10, and a plurality of solenoid-operated valve manifolds 11a, 11b, . . . are connected in series respectively via a plurality of branched passages 7a, 7b, . . . on the output side of the air drier 6. Plural air cylinders 12a to 12c are connected in parallel to the solenoid-operated valve manifold 11a. A silencer 14 is connected to a common discharge port 13 of the solenoid-operated valve manifold 11a, which communicates with atmospheric air.

Operation of the air circuit 1 shall be explained schematically. A large volume of compressed air, derived from the compressor 2, flows through the after cooler 3, the air tank 4, the first filter 5, and the air drier 6 respectively. Accordingly, for example, temperature, humidity, and pulsation are controlled.

Compressed air, which has been controlled as described above, is appropriately distributed via the branched passages 7a, 7b, . . . , and then the pressure of the compressed air is reduced to a predetermined pressure corresponding to each of the air cylinders 12a to 12c by the aid of the pressure-reducing valve 9. Further, compressed air is supplied from common supply ports 15 to the solenoid-operated valve manifolds 11a, 11b, . . . In the solenoid-operated valve manifold 11a, compressed air is supplied to one cylinder chamber 16a of each of the air cylinders 12a to 12c via respective unillustrated ports that communicate with the common supply port 15. Accordingly, the respective air cylinders 12a to 12c are driven.

When each of the air cylinders 12a to 12c is driven, air derived from the other cylinder chamber 16b is discharged to the atmosphere via the common discharge port 13 of the solenoid-operated valve manifolds 11a, 11b, . . . and the silencer 14.

As described above, in the case of the conventional air circuit 1, when the air cylinders 12a to 12c are driven, the entire amount of air, which is discharged from the air cylinders 12a to 12c, is discharged to the atmosphere without being reused, whereupon the operation proceeds to the next step.

In view of the above, as shown in FIG. 19, an exhaust air recovery circuit 20 has been proposed in order to recover and reuse exhausted air while maintaining pressure, as described in “Energy Saving for Pneumatic System,” first edition, written by Naotake ONEYAMA, and published by The Energy Conservation Center, Mar. 31, 2003, pp. 306-307.

The exhaust air recovery circuit 20 is constructed such that high pressure air, which is supplied to a head side cylinder chamber 22a during the operational stroke of an air cylinder 21, is recovered in an accumulator 24 via a recovery valve 23 until the pressure is lowered to a predetermined pressure. Meanwhile, air is discharged to the atmosphere from the recovery valve 23 when the pressure is lowered below a predetermined pressure. The low pressure air, which is recovered by the accumulator 24, is utilized as an air source for a rod side cylinder chamber 22b, during its return stroke, and thus the air cylinder 21 is driven dually.

### SUMMARY OF THE INVENTION

A general object of the present invention is to provide a fluid circuit system, which enables energy savings by improving the operational efficiency of a compressor for supplying a supply gas in a closed loop fluid circuit in which a gas such as air is circulated.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 shows a circuit diagram illustrating a fluid circuit system according to a first embodiment of the present invention;

FIG. 2 shows characteristics for illustrating the relationship between enthalpy and entropy in the fluid circuit system according to the first embodiment, and in a fluid circuit system according to a first comparative embodiment;

FIG. 3 shows a circuit diagram illustrating a fluid circuit system according to a second embodiment of the present invention;

FIG. 4 shows a circuit diagram illustrating a fluid circuit system according to a third embodiment of the present invention;

FIG. 5 shows another circuit diagram illustrating a fluid circuit system according to the third embodiment of the present invention;

FIG. 6 shows a circuit diagram illustrating a fluid circuit system according to a fourth embodiment of the present invention;

FIG. 7 shows a circuit diagram illustrating a fluid circuit system according to a fifth embodiment of the present invention;

FIG. 8 shows a longitudinal sectional view illustrating in greater detail a manifold frame and a third double tube joint, as shown in FIG. 7;

FIG. 9 shows a circuit diagram illustrating a fluid circuit system according to a sixth embodiment of the present invention;

FIG. 10 shows a partial magnified vertical sectional view illustrating in greater detail a suction unit and a double tube, as shown in FIG. 9;

FIG. 11 shows a circuit diagram illustrating the fluid circuit system according to a first comparative embodiment;

FIG. 12 shows a circuit diagram illustrating a fluid circuit system according to a second comparative embodiment;

FIG. 13 shows a circuit diagram illustrating a fluid circuit system according to a third comparative embodiment;

FIG. 14 shows a schematic arrangement of a compressor provided with a plurality of air-compressing mechanisms;

FIG. 15 shows a circuit diagram illustrating a single operational state of the air-compressing mechanisms, which make up the compressor shown in FIG. 14;

FIG. 16 shows a circuit diagram illustrating a serial operational state of the air-compressing mechanisms, which make up the compressor shown in FIG. 14;

FIG. 17 shows a circuit diagram illustrating a parallel operational state of the air-compressing mechanisms, which make up the compressor shown in FIG. 14;

FIG. 18 shows a circuit diagram of an air circuit in accordance with the conventional technique; and

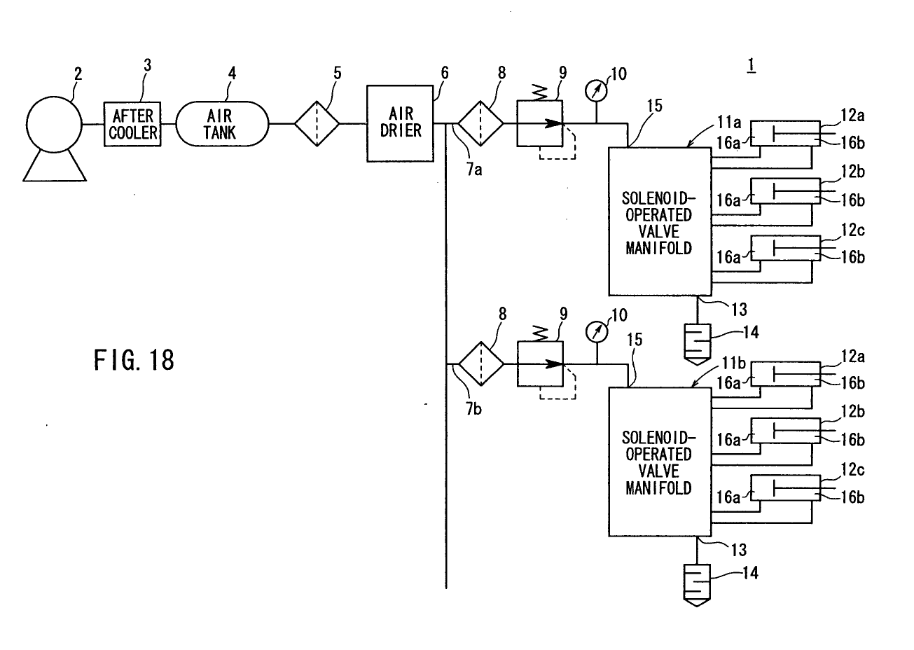

FIG. 19 shows a circuit diagram illustrating an exhaust gas recovery circuit in accordance with the conventional technique.

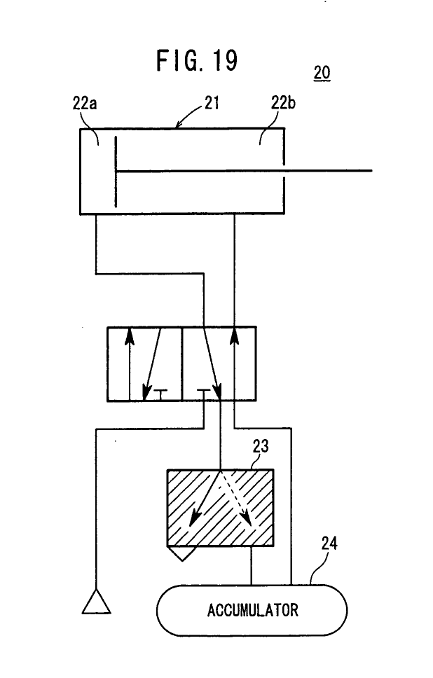

### DESCRIPTION OF THE PREFERRED EMBODIMENTS

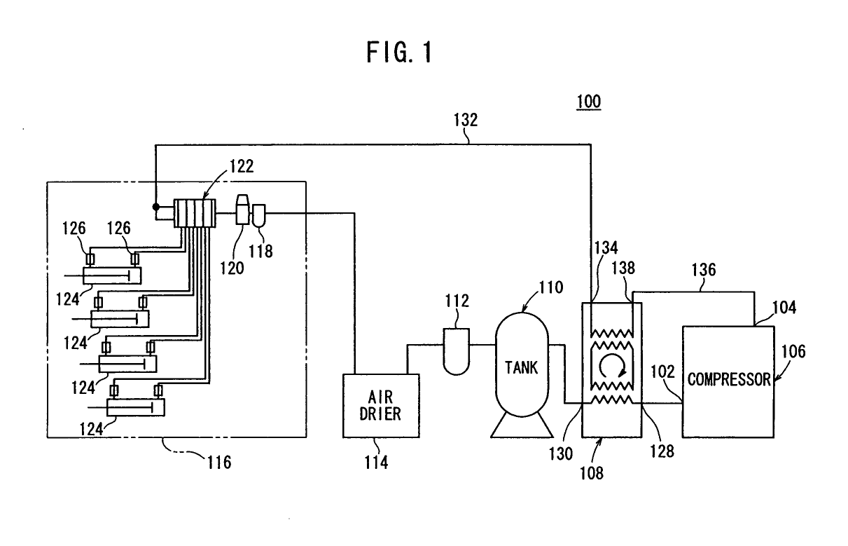

With reference to FIG. 1, reference numeral 100 indicates a fluid circuit system according to a first embodiment of the present invention. In the following inventive and comparative embodiments, the same constitutive components are designated with the same reference numerals, and detailed explanation thereof shall be omitted.

The fluid circuit system 100 according to the first embodiment is composed of a pressurized fluid-circulating circuit constructing a closed loop. The fluid circuit system 100 comprises a compressor 106 provided with an air supply port 102 and an air aspiration port 104, a heat exchange unit (heat exchange mechanism) 108, which is connected to the air supply port 102 and the air aspiration port 104 of the compressor 106 respectively, a tank 110 which temporarily stores a supply gas, such as compressed air and gas supplied from the compressor 106, and which suppresses pulsations in the compressed air, a filter 112 which removes dust or the like contained in the compressed air derived from the tank 110, and an air drier 114 which cools the compressed air having passed through the filter 112.

The fluid circuit system 100 further comprises a filter 118 and a regulator 120, to which the pressurized fluid from the air drier 114 is supplied, and which are connected to the piping passage of the factory equipment 116, a solenoid-operated valve manifold 122 which is connected to the output side of the regulator 120, a plurality of air cylinders 124 which are driven respectively in accordance with the supply of pressurized fluid via a plurality of branched passages connected to the solenoid-operated valve manifold 122, and speed controllers 126 which adjust the flow rates of compressed air supplied to cylinder chambers of the air cylinders 124.

The heat exchange unit 108 includes a high temperature air supply port 128 connected to the air supply port 102 of the compressor 106, a first connecting port 130 connected to the tank 110, a low temperature air supply port 134 connected to a discharge port of the solenoid-operated valve manifold 122 via a first circulating passage 132, and a second connecting port 138 connected to the air aspiration port 104 of the compressor 106 via a second circulating passage 136.

In this arrangement, the high temperature air supply port 128 and the first connecting port 130 communicate via a first communication passage, and the low temperature air supply port 134 and the second connecting port 138 communicate via a second communication passage.

As described above, the compressor 106, the heat exchange unit 108, and other components are connected to each other in a closed loop. The compressor 106 may also be connected to an unillustrated supply tank, which initially supplies pressurized fluid to the closed loop, and/or which replenishes the closed loop with a previously stored pressurized fluid when a decrease occurs in the pressurized fluid in the closed loop. Further, pressurized fluid, such as a gas that has been previously produced according to predetermined quality controls, may be stored in the supply tank.

The fluid circuit system 100 according to the first embodiment of the present invention is basically constructed as described above. Next, its operations, functions and effects shall be explained.

Air, which is aspirated by the compressor 106, is compressed internally, and the temperature of the compressed air is raised. Compressed air having a high temperature is discharged from the air supply port 102. The compressed air is then introduced into a high temperature air supply port 128 of the heat exchange unit 108, and the compressed air is supplied to the tank 110 via the first communication passage and first connecting port 130.

Compressed air derived from the tank 110 passes through the filter 112, and the compressed air is introduced into the air drier 114. The air drier 114 functions so that water contained in the compressed air is separated out to provide dry air, and the lowered temperature of the air is restored to a temperature in the vicinity of normal temperature.

Usually, in the case of blown air or the like, no problem arises concerning use thereof with compressed air having its quality adjusted to some extent. However, when an actuator system composed of, for example, the solenoid-operated valve manifold 122 and the plurality of air cylinders 124, is used with the factory equipment 116, use of compressed air having better quality makes it possible to prolong the service life of the equipment making up the actuator system and maintain a satisfactory operational state. Therefore, it is preferable to use a filter and mist separator.

Pressure of the compressed air, which has its quality controlled until arrival at a final stage, is adjusted by the regulator 120, and the compressed air is supplied to the solenoid-operated valve manifold 122. A desired air cylinder 124 can be driven by the aid of a solenoid-operated valve, wherein the solenoid-operated valve is energized by an energizing signal fed from an unillustrated controller.

During this process, the flow rate of the supplied compressed air is decreased by the speed controller 126. Thus, the displacement speed of an unillustrated piston in the air cylinder 124 can be adjusted.

Air that remains in the cylinder chamber of the air cylinder 124 is discharged from the discharge port of the solenoid-operated valve manifold 122 by a displacement action of the piston. Low temperature exhaust air, which is discharged from the discharge port, is introduced into the heat exchange unit 108 via the first circulating passage 132 and the low temperature air supply port 134.

Heat exchange is effected in the heat exchange unit 108 between the high temperature compressed air (supply gas) introduced from the high temperature air supply port 128 and the low temperature exhaust air (return gas) introduced from the low temperature air supply port 134. Thermal energy of the high temperature compressed air is migrated to the low temperature exhaust air. Therefore, the temperature of the compressed air is lowered, while the temperature of the exhaust air is raised. Exhaust air, after having its temperature raised, is introduced into the compressor 106 from the air aspiration port 104 via the second circulating passage 136.

Accordingly, it is unnecessary to replenish thermal energy from the outside, and the enthalpy of the air aspirated by the compressor 106 is raised. As a result, thermal energy, which would otherwise be released to the outside, is decreased, thus enabling energy savings.

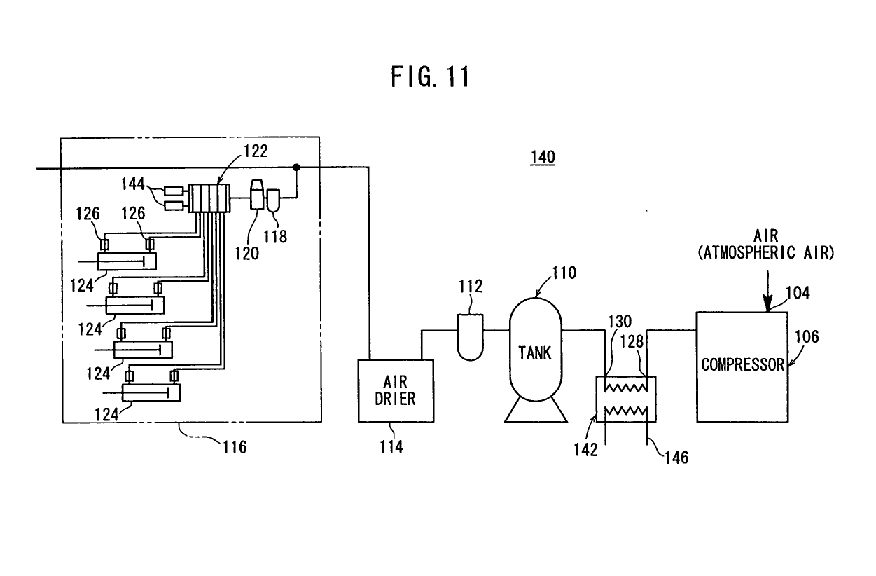

A fluid circuit system 140 according to a first comparative embodiment is shown in FIG. 11.

The fluid circuit system 140 according to the first comparative embodiment is different from the first embodiment in that an after cooler 142, which performs cooling using a liquid, is connected to the output side of the compressor 106. Further, exhaust air, which is discharged from the air cylinders 124, is discharged to atmospheric air from a silencer 144 connected to the discharge port of the solenoid-operated valve manifold 122.

High temperature compressed air, which is introduced into the after cooler 142 via piping, is cooled by circulating industrial water or oil connected to an oil cooler within cooling piping 146, and thermal energy is released to atmospheric air. Accordingly, the temperature of the compressed air is lowered.

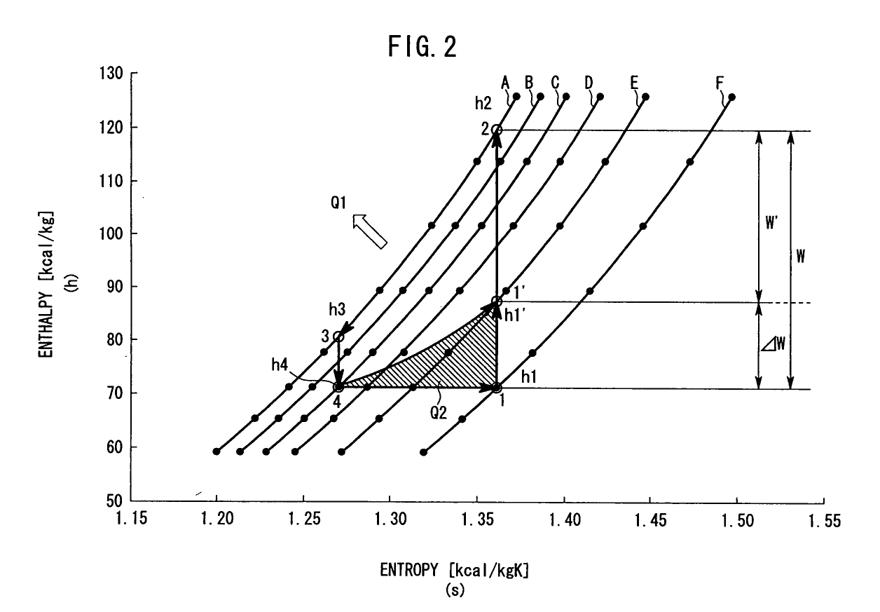

Next, FIG. 2 shows the relationship between enthalpy and entropy in the fluid circuit system 100 according to the first embodiment and the fluid circuit system 140 according to the first comparative embodiment. The characteristic curves A to F depicted in FIG. 2 indicate respective states in which the pressures of the compressed air are 0 kgf/cm², 1 kgf/cm², 2 kgf/cm², 3 kgf/cm², 4 kgf/cm², and 5 kgf/cm² respectively. The enthalpy (h) indicates the energy (amount of heat) sent/received when a gas, such as compressed air, is subjected to an isobaric change, and the entropy (s) indicates the quantity of state of the gas.

When the compressor 106 is used in an ordinary state, for example, air (atmospheric air) or N₂ gas having an enthalpy (h1) is compressed on the basis of a preset compression ratio by the compressor 106 based on, for example, a scroll system, a screw system, a reciprocal system, a vane system, or a turbo system.

Compressed air, which has been raised in pressure by the compressor 106, also has its temperature raised in accordance with an adiabatic change. Since the temperature of the compressed air is in a proportional relationship with respect to enthalpy, the enthalpy of the compressed air is increased to h2. During this process, work (power source required for compression), which is performed by the compressor 106, is W (changing from State 1 to State 2).

If compressed air, after being compressed and having acquired a high enthalpy state, is used, as is, for the actuator system, it is feared that troubles may occur by exceeding the applicable temperature ranges of the fluid equipment including, for example, the tank 110, the regulator 120, the filter 112, the piping, the tube joint, the solenoid-operated valve, the flow rate-adjusting valve, and the air cylinder 124. Accordingly, in general, in order to lower the temperature of the compressed air, adjustments are made to obtain temperatures within the applicable ranges for the fluid equipment using, for example, the after cooler 142 and the refrigerating-type air drier.

However, the enthalpy of the compressed air is decreased from h2 to h3 as a result of being released to atmospheric air, in accordance with a temperature adjustment (change from State 2 to State 3). This decrease in enthalpy from h2 to h3 also indicates the fact that energy Q1 is released to atmospheric air. In addition, therefore, compressed air having an appropriate temperature performs desired work using the actuator system. Enthalpy is further decreased from h3 to h4, and the pressure of the compressed air is lowered (change from State 3 to State 4).

In the fluid circuit system 140 according to the first comparative embodiment, compressed air having an enthalpy h4, existing in the closed space between the air cylinders 124 and the solenoid-operated valve manifold 122 of the actuator system, is discharged to atmospheric air when the displacement direction of the piston is switched, in accordance with an energizing/deenergizing action of the solenoid-operated valve. Thus, pressure is lowered while remaining in the same temperature state (change from State 4 to State 1).

In contrast, in the fluid circuit system 100 according to the first embodiment, exhaust air, which would be otherwise released to atmospheric air, is not discharged, but instead the exhaust air is introduced again into the heat exchange unit 108 via the first circulating passage 132. Accordingly, it is possible to increase the enthalpy to h1′. Therefore, a reduction can be achieved, in an amount corresponding to the energy Q2 required to cause an increase of the compressed air to a state in which the enthalpy is h2 again (see the hatched portion shown in FIG. 2).

Therefore, in the first comparative embodiment, the state is changed, i.e., from State 1→State 2→State 3→State 4→State 1. On the other hand, in the first embodiment, the state is changed, i.e., from State 1′→State 2→State 3→State 4→State 1′. Therefore, operations can be performed more efficiently by reducing the power for the compressor 106, and an energy saving in an amount corresponding to the energy Q2 can be achieved.

In other words, the first comparative embodiment, which is based on using the after cooler 142 and aimed only at decreasing the temperature of the high temperature compressed air, involves the following problem. That is, the amount of heat generated when the temperature of the compressed air is lowered, is thermally conducted to water or oil, which act as a circulating cooling liquid, and as a result, this amount of heat is released from the fluid circuit to the outside.

In contrast, in the first embodiment, a first circulating passage 132 is provided, which connects the heat exchange unit 108 and the discharge port of the solenoid-operated valve manifold 122. Exhaust air, which has a low temperature, is aspirated into the heat exchange unit 108 during the discharge operation of the air cylinder 124. Thus, heat exchange is effected in the heat exchange unit 108 between the high temperature compressed air from the compressor 106 and the low temperature exhaust air.

Therefore, in the first embodiment, heat exchange is performed such that the temperature of the high temperature compressed air is decreased, while the temperature of the low temperature exhaust air is raised. Exhaust air, which is reheated to the raised temperature, is aspirated via the air aspiration port 104 of the compressor 106. As a result, in the first embodiment, it is unnecessary to replenish thermal energy from the outside. The enthalpy of the air aspirated by the compressor 106 is raised, and the energy released to the outside is decreased. Thus, substantial energy savings can be obtained.

During this procedure, all of the energy Q1, corresponding to the endothermic action effected until arrival at the temperature of use in relation to the increase in temperature (increase in enthalpy) caused by air compression performed by the compressor 106, is not released to the environment (atmospheric air). Rather, the increase in enthalpy (increase in the temperature) of the air aspirated by the compressor 106 is reused. Accordingly, it is possible to decrease the required pressurizing work during the air compression step, and thus it is possible to raise the operation efficiency of the compressor 106.

More specifically, in the case of an ideal gas, there is given Entropy h1≈Entropy h4. However, by effecting the above-described heating, is possible to give Entropy h1′>Entropy h4. Assuming that W and W′ represent the work (required power) performed by the compressor 106 with respect to the compressed air, the following expressions are obtained.
W≈h2−h1
W′≈h2−h1′
Therefore, there is given ∇W=W−W′>0 whereby energy savings is achieved in an amount corresponding to ∇W.

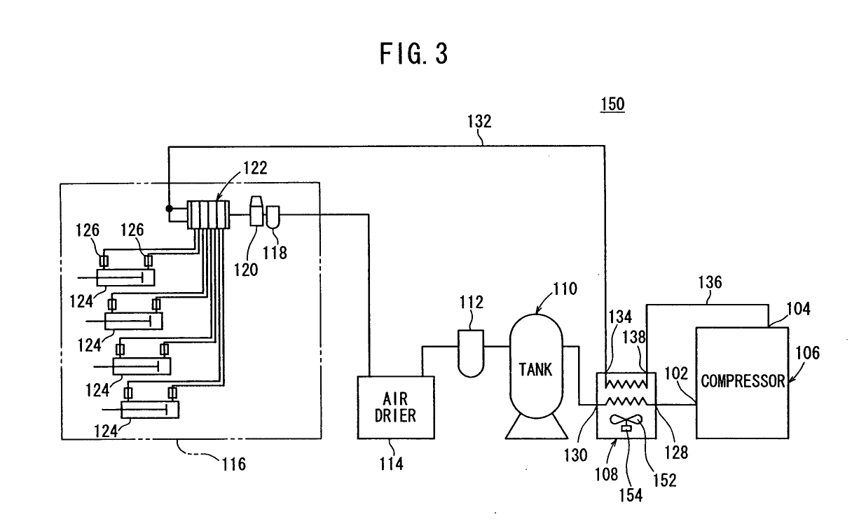

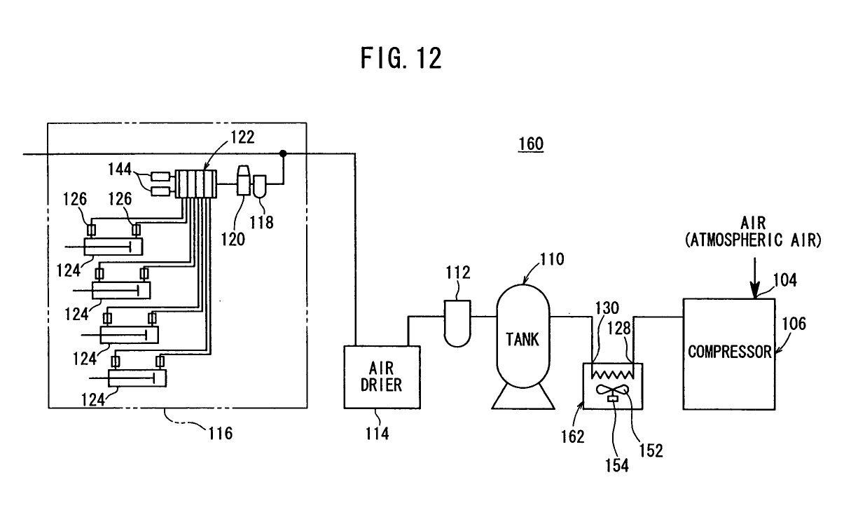

Next, FIG. 3 shows a fluid circuit system 150 according to a second embodiment, whereas FIG. 12 shows a fluid circuit system 160 according to a second comparative embodiment. In the following embodiments, detailed explanation of any functions and effects that are the same as those of the first embodiment shall be omitted, and explanations shall be given only where such functions and effects differ.

The second embodiment is different from the first embodiment in that the heat exchange unit 108 includes a fan 152 therein, which effects thermal conduction by ventilating the heat from the high temperature compressed air, obtained from the compressor 106, to the piping through which the low temperature exhaust air flows. The fan 152 is rotatably driven by the aid of an electric motor 154 or the like.

In the second comparative embodiment, high temperature compressed air, which is derived from the compressor 106, is cooled by an air-cooling type after cooler 162, also based on the use of a fan 152. However, the second comparative embodiment involves the problem that thermal energy is released to atmospheric air, as the temperature of the compressed air is lowered during this process, and therefore it is impossible to efficiently utilize such thermal energy.

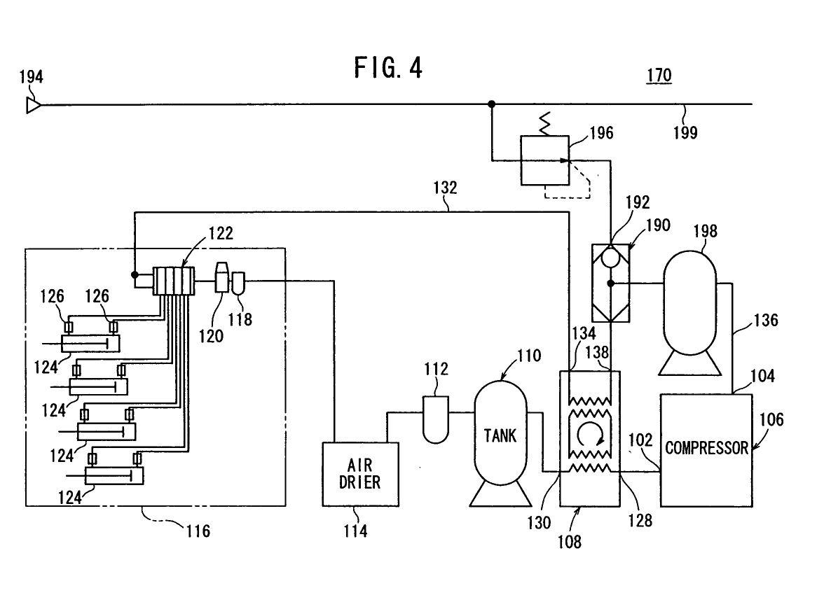

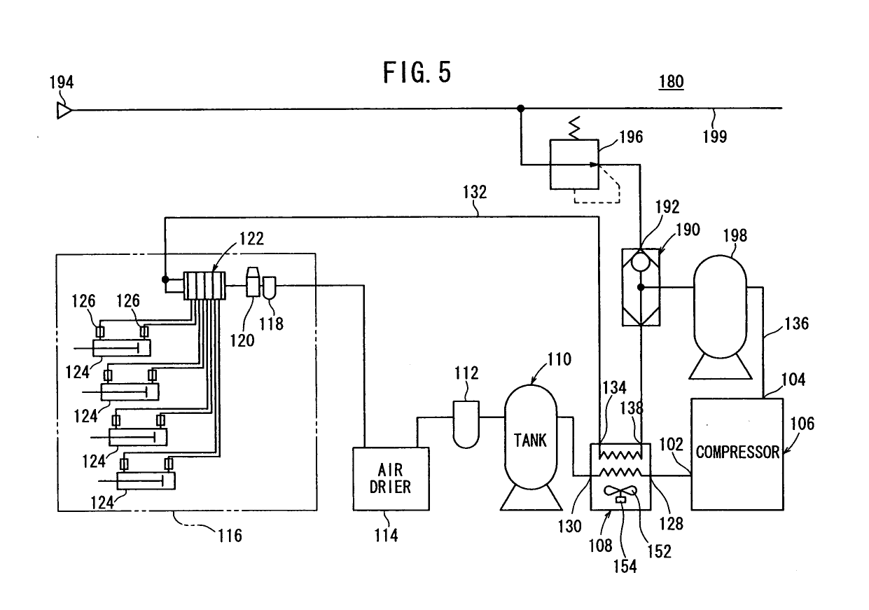

Next, FIGS. 4 and 5 show fluid circuit systems 170, 180 according to a third embodiment.

The third embodiment is different from the first and second embodiments in that a pressure supply mechanism 190 is connected to the second circulating passage 136 between the heat exchange unit 108 and the compressor 106.

The pressure supply mechanism 190 includes a shuttle valve 192 connected to the second connecting port 138 of the heat exchange unit 108, a regulator 196 connected to another compressed air supply source 194, wherein the regulator 196 reduces to a predetermined pressure the pressure of the replenished compressed air supplied to the shuttle valve 192, and an exhaust air recovery tank 198 arranged between the shuttle valve 192 and the compressor 106.

Exhaust air, which is derived from the heat exchange unit 108 via the second connecting port 138, is introduced into the shuttle valve 192. When the pressure is higher than the pressure of the low pressure compressed air preset by the regulator 196, the exhaust air is supplied, as is, to the exhaust air recovery tank 198 via the shuttle valve 192. Further, exhaust air is introduced into the compressor 106 via the air aspiration port 104 of the compressor 106. During this process, air is not consumed from the compressed air supply line 199, since the compressed air supply line 199 forms a separate line connected to another compressed air supply source 194.

When the flow rate of the compressed exhaust air decreases, and the pressure in the exhaust air recovery tank 198 becomes lower than the preset pressure of the regulator 196, then the shuttle valve 192 is operated. Thus, compressed air, which is fed from the compressed air supply line 199, and which as noted above forms a separate line connected to another compressed air supply source 194, is supplied into the exhaust air recovery tank 198 via the shuttle valve 192.

By providing the pressure supply mechanism 190 and the exhaust air recovery tank 198, a constant discharge side pressure (pressure of the exhaust air) is always retained. Therefore, it is possible to stably operate the compressor 106 for effectively utilizing the exhaust air.

The fluid circuit system 180 shown in FIG. 5 is different from the fluid circuit system 170 shown in FIG. 4 in that a fan 152 and an electric motor 154 are provided. Otherwise, the arrangement is the same.

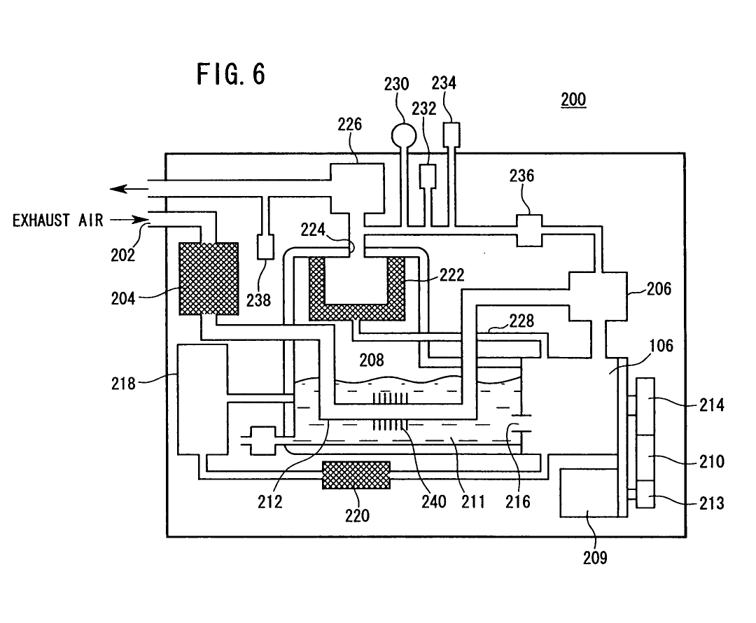

FIG. 6 shows a fluid circuit system 200 according to a fourth embodiment.

Exhaust air, which is aspirated from an aspiration port 202 via an unillustrated circulating passage, passes through an air cleaner 204 to remove dust or the like contained in the air, and the exhaust air is introduced into an aspiration volume-adjusting valve 206. Heat exchange piping 212, which is immersed in lubricating oil 211 contained in an oil chamber 208, is arranged between the air cleaner 204 and the aspiration volume-adjusting valve 206. Low temperature air, which has passed through the air cleaner 204, is introduced into the aspiration volume-adjusting valve 206 via the heat exchange piping 212.

The aspiration volume-adjusting valve 206 operates such that, when it is detected that the pressure of air introduced into the inside of the aspiration volume-adjusting valve 206 is raised higher than a preset pressure, the aspiration passage is closed in order to avoid excessive aspiration of air.

Air that has passed through the aspiration volume-adjusting valve 206 is introduced into the compressor 106, whereupon the air is compressed to provide compressed air. The compressor 106 may be based on, for example, any one of a twin screw system, a scroll system, a reciprocal system, a vane system, and a turbo system.

In the compressor 106, a rotational force from a motor 209 driven by a supplied power source is transmitted from a small pulley 213 to a large pulley 214, by means of a rotary driving force-transmitting means, such as a V-belt 210 and a timing belt, wherein the number of revolutions is decreased and the speed of rotation is decelerated. Using this arrangement, when the pulley diameter is exchanged to other sizes, it is possible to change the number of revolutions provided by an inexpensive induction motor, which rotates at a constant number of revolutions. As a result, it is possible to change the discharge flow rate of the compressed air.

Compressed air, having been raised in pressure by the compressor 106, is released from the output port 216 into the oil chamber 208. Lubricating oil 211, to which the heat of the compressed air having a high temperature is transmitted, is accommodated in the oil chamber 208. The high temperature compressed air is mixed with the lubricating oil 211. The lubricating oil 211, thus having been raised in temperature, is extruded by the internal pressure of the oil chamber 208 and the lubricating oil 211 flows into an oil cooler 218. The temperature of the lubricating oil 211 is lowered in the oil cooler 218. Further, when the lubricating oil 211 passes through an oil filter 220, impurities such as dust and metal powder contained in the lubricating oil 211 are filtered out. The lubricating oil 211 is fed into the compressor 106, and the lubricating oil 211 is returned to the oil chamber 208 along with compressed air, again through operation of the compressor 106.

Compressed air, which contains the lubricating oil 211 in the oil chamber 208, passes through an oil separator 222 for removing the oil component. The compressed air is then fed from a chamber outlet 224 to a pressure-keeping valve 226. Lubricating oil 211, having been separated by the oil separator 222, is extruded as a result of the internal pressure inside the oil chamber 208, and the lubricating oil 211 is returned to the compressor 106 via piping 228.

Compressed air that is introduced into the pressure-keeping valve 226 has a pressure, which is automatically regulated so that the pressure is more than a prescribed value inherent in every compressor 106. Accordingly, deterioration of the separating function of the oil separator 222 is avoided beforehand, along with any shortage in the lubricating amount of the lubricating oil 211 caused thereby. Further, excessive heating of the compressor 106, which would be otherwise caused by a decrease in the pressure when the air consumption amount is larger than the discharge air flow rate, can be avoided. The pressure in the oil chamber 208 is branched at the chamber outlet 224, so as to communicate and connect with the subsequent equipment.

In FIG. 6, reference numeral 230 indicates a discharge air pressure gauge by which the pressure can be observed, reference numeral 232 indicates a safety valve which automatically reduces the pressure in the oil chamber 208 whenever the pressure is abnormal, and reference numeral 234 indicates a manual release valve which is opened manually when the pressure in the oil chamber 208 is in a reduced state, for example, when replenishing the lubricating oil 211 after stopping the compressor 106.

Reference numeral 236 indicates a solenoid-operated valve, which is designed as follows. That is, the solenoid-operated valve 236 is normally in an ON state. When compressed air, which is branched from the chamber outlet 224, is directly introduced into the aspiration volume-adjusting valve 206 and the compressed air has a pressure not less than the preset pressure, then the solenoid-operated valve 236 is placed in an OFF state. Moreover, when it is detected, by a pressure switch 238, that the pressure of the compressed air discharged from the secondary side of the pressure-keeping valve 226 is lower than a preset pressure, then the solenoid-operated valve 236 is placed in an OFF state on the basis of a detection signal derived from the pressure switch 238, and the aspiration volume-adjusting valve 206 is opened again to form compressed air.

In the fourth embodiment, during the driving of the air cylinders, exhaust air aspirated from the aspiration port 202 passes through the air cleaner 204, and then the exhaust air flows along the heat exchange piping 212 immersed in lubricating oil 211 in the oil chamber 208. In the heat exchange piping 212 it is preferable for fins 240, which increase the coefficient of thermal conductivity, to be formed on an outer circumferential surface of the piping, for example, as in an ever-fin tube.

When exhaust air passes through the heat exchange piping 212, then the enthalpy of the exhaust air is increased by the high temperature lubricating oil 211, and exhaust air having been raised in temperature is aspirated and compressed by the compressor 106. As a result, the amount of thermal energy released to atmospheric air from the oil cooler of the compressor 106 is decreased, and work necessary for performing the compressing step by the compressor 106 is decreased. Thus, it is possible to achieve energy savings.

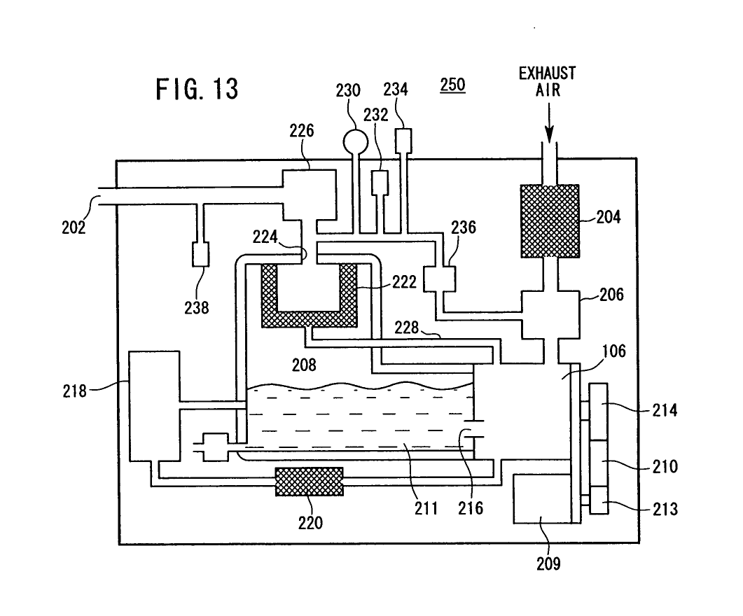

FIG. 13 shows a fluid circuit system 250 according to a third comparative embodiment.

The fluid circuit system 250 according to the third comparative embodiment has a structure wherein atmospheric air, at an ordinary temperature, is aspirated as is, thereby making up the air that is aspirated by the compressor 106. Heat exchange piping 212 is not provided. With this structure, it is impossible to decrease the thermal energy during the compressing step performed by the compressor 106.

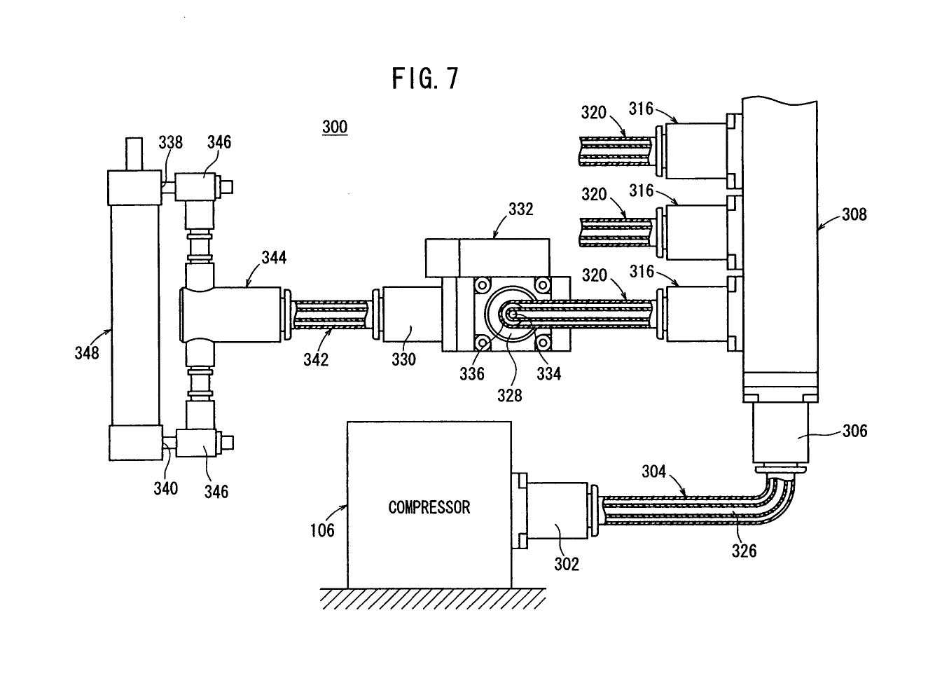

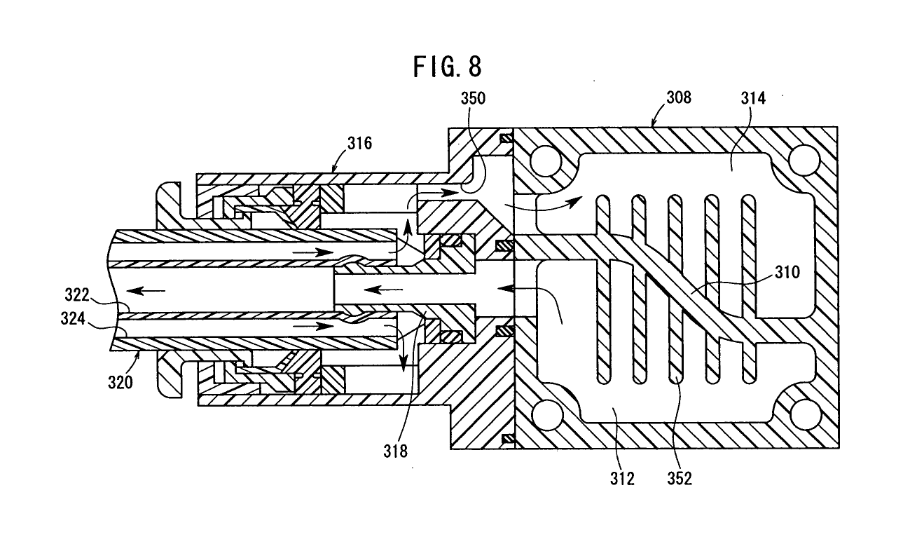

Next, FIGS. 7 and 8 show a fluid circuit system 300 according to a fifth embodiment of the invention, which is based on the use of double tubes.

High temperature compressed air derived from a compressor 106 passes through an inner tube of a first double tube 304, via a first double tube joint 302 connected to the compressor 106, and the compressed air is introduced into a manifold frame 308 via a second double tube joint 306 disposed on a primary side.

As shown in FIG. 8, the manifold frame 308 is provided with a first chamber 312 disposed on a lower side and a second chamber 314 disposed on an upper side, both of which are constructed separately by a partition wall 310 arranged at a substantially central portion. A plurality of third double tube joints 316 is connected to the secondary side of the manifold frame 308. An inner tube passage 322 of the second double tube 320, which is connected with the third double tube joint 316, is connects and communicates with the first chamber 312 disposed on the lower side by means of an inner collector 318 provided for the third double tube joint 316. An outer tube passage 324 of the second double tube 320 connects and communicates with the second chamber 314 disposed on the upper side (see FIG. 8).

In this arrangement, high temperature compressed air, which has passed through the inner tube passage 326 of the first double tube 304, is introduced into the first chamber 312 disposed on the lower side of the manifold frame 308. Further, the compressed air passes through the inner collector 318 of the third double tube joint 316, so as to flow along the inner tube of the second double tube 320. Compressed air also is introduced into a solenoid-operated valve 332, to which a fourth double tube joint 328 on the primary side, and a fifth double tube joint 330 on the secondary side, are connected respectively.

The solenoid-operated valve 332, to which the fourth double tube joint 328 on the primary side and the fifth double tube joint 330 on the secondary side are connected respectively, has a structure that differs from that of a conventional double tube solenoid-operated valve in the following point. That is, a conventional double tube solenoid-operated valve has a compressed air supply port composed of a single tube system. Further, double tube joints are connected only to an A port and a B port, which are connected to a cylinder. The supply and discharge ports are ports for the single tube.

In contrast, the solenoid-operated valve 332 that is incorporated into the fluid circuit system 300 according to the fifth embodiment differs in that a supply port 334 and a discharge port 336 are integrally connected by a fourth double tube joint 328 disposed on the primary side respectively. The fifth double tube joint 330, disposed on the secondary side of the solenoid-operated valve 332, is constructed in the same manner as in a conventional solenoid-operated valve, having a piping structure in which the distribution is effected with an A port 338 and a B port 340.

One end of a third double tube 342 is connected to the fifth double tube joint 330 disposed on the secondary side of the solenoid-operated valve 332. A T-joint 344, which distributes the double tube into single tubes, is connected to the other end of the third double tube 342. A pair of speed controllers 346 is connected via single tubes on the downstream side of the T-joint 344. Compressed air is introduced into the speed controller 346 via the inner tube of the third double tube 342 and the T-joint 344. Compressed air, the pressure of which is reduced to a predetermined pressure by the speed controller 346, is supplied to one cylinder chamber in which a piston is accommodated, via the A port 338 or the B port 340 of a cylinder 348. Thus, work is performed to press the piston.

During the exhausting step, exhaust air, which is discharged from the other cylinder chambers after completion of the work, is gathered in the outer tube passage formed between the inner tubes and the outer tubes of the first to third double tubes 304, 320, 342. Exhaust air that is discharged via the outer tube passage passes through an outer circumferential passage 350 of the inner collector 318 of the third double tube joint 316, and the exhaust air is introduced into the second chamber 314 disposed on the upper side of the manifold frame 308. In this situation, heat exchange is effected by means of heat release fins 352 formed on the partition wall 310 between the first chamber 312 disposed on the lower side to which high temperature compressed air is supplied and the second chamber 314 disposed on the upper side to which low temperature exhaust air is supplied. The temperature of the high temperature compressed air is lowered, and the temperature of the low temperature exhaust air is raised. Exhaust air, the enthalpy of which is raised by heat exchange, passes through the outer tube passage of the first double tube 304 after passing through the second double tube joint 306. The exhaust air is aspirated into the internal aspiration port via the first double tube joint 302 connected to the compressor 106.

The manifold frame 308 is produced by means of extrusion forming using a light metal such as aluminum, having an identical cross-sectional shape in the axial direction. The manifold frame 308 can be designed to have any arbitrary length in the axial direction corresponding to, for example, the number of cylinders 348 and the number of solenoid-operated valves 332.

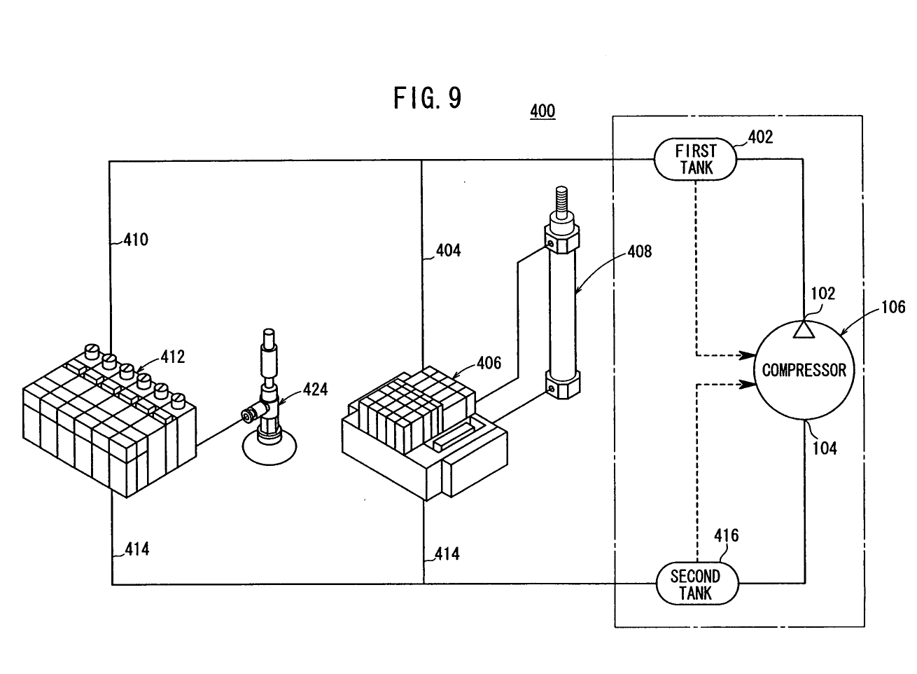

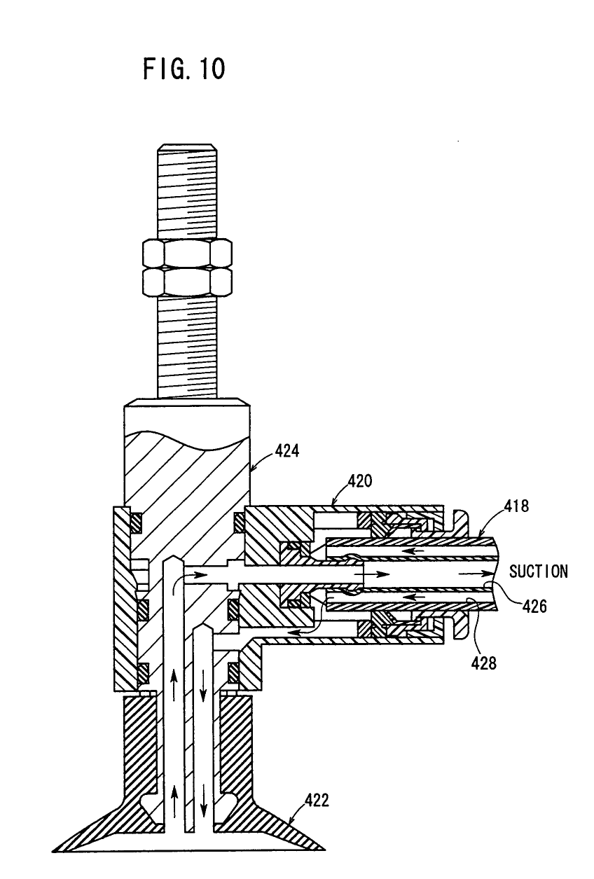

Next, a fluid circuit system 400 according to a sixth embodiment is shown in FIGS. 9 and 10.

The fluid circuit system 400 comprises a compressor 106, a first tank 402 connected to an air supply port 102 of the compressor 106, a solenoid-operated valve manifold 406 and air cylinders 408 connected to the output side of the first tank 402 via a first passage 404, a vacuum pump mechanism 412 connected to the output side of the first tank 402 via a second passage 410 branched from the first passage 404, and a second tank 416 connected to the solenoid-operated valve manifold 406 and the suction side of the vacuum pump mechanism 412 via a third passage 414.

Positively pressurized air is stored in the first tank 402, and negatively pressurized air is stored in the second tank 416.

As shown in FIG. 10, a suction unit 424, to which a suction pad 422 is installed via a double tube 418 and a double tube joint 420, is connected to the vacuum pump mechanism 412. In this arrangement, fluid at a negative pressure is supplied along an inner tube passage 426 formed by an inner tube of the double tube 418. Thus, an unillustrated workpiece may be sucked by the suction pad 422.

On the other hand, fluid having a positive pressure for breaking the vacuum, which is used to disengage the workpiece, is supplied via an outer tube passage 428 formed between the inner tube and the outer tube of the double tube 418. When the double tube 418 is provided so that positively pressurized fluid and negatively pressurized fluid are allowed to flow in an integrated manner via the double tube 418, it is possible to prevent the positively pressurized fluid from becoming contaminated with dust or the like.

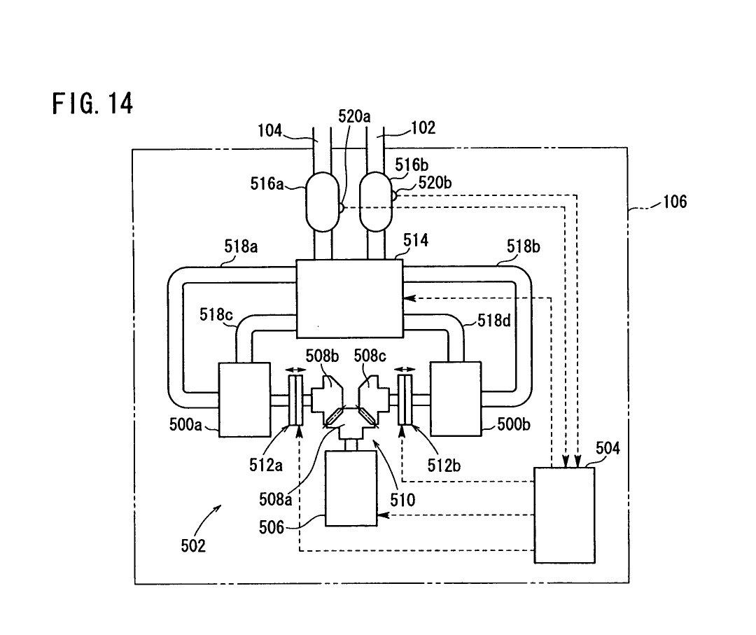

Next, FIG. 14 shows a schematic structure of a compressor 106.

The compressor 106, which is usable in the embodiments of the present invention, may be provided with a single air-compressing mechanism. However, as shown in FIG. 14, the compressor 106 may also be provided with plural air-compressing mechanisms 502, including a first air-compressing mechanism 500a and a second air-compressing mechanism 500b.

The compressor 106 comprises a servo motor 506 or an induction motor employing an inverter control in which, for example, the number of revolutions and rotational torque are controlled on the basis of a control signal supplied by a control unit 504, a bevel gear mechanism 510 including second and third bevel gears 508b, 508c meshed with a first bevel gear 508a coupled to a motor shaft of the servo motor 506 (or induction motor). First and second electromagnetic clutches 512a, 512b are connected to the second and third bevel gears 508b, 508c respectively, for transmitting the rotational force of the servo motor 506 to a first air-compressing mechanism 500a and/or a second air-compressing mechanism 500b, on the basis of an energizing/deenergizing signal supplied from the control unit 504.

The compressor 106 further comprises a first air tank 516a provided in a passage communicating between an air aspiration port 104 and a directional control valve 514, and a second air tank 516b provided in a passage communicating between an air supply port 102 and the directional control valve 514. The directional control valve 514 changes the supply of air introduced from the air aspiration port 104 to any one of the first and second air-compressing mechanisms 500a, 500b, and further, branches air introduced from the air aspiration port 104 to change the supply to both of the first and second air-compressing mechanisms 500a, 500b. The compressor also comprises first to fourth changeover passages 518a to 518d which connect the directional control valve 514 and the first and second air-compressing mechanisms 500a, 500b, along with first and second pressure sensors 520a, 520b which detect the respective pressures of air stored in the first and second air tanks 516a, 516b to supply detection signals to the control unit 504 respectively.

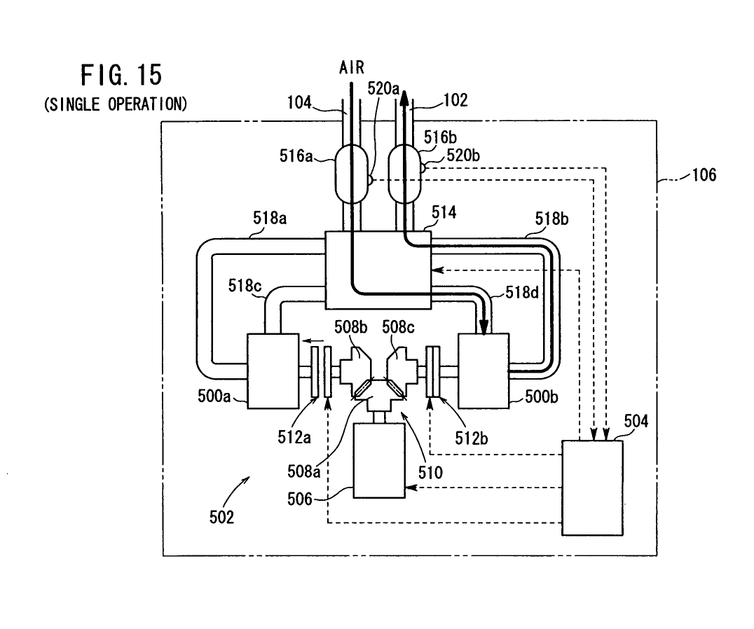

FIG. 15 shows a state in which only the second air-compressing mechanism 500b is operated alone, by cutting off the connection of the first electromagnetic clutch 512a that transmits rotational torque to the first air-compressing mechanism 500a on the basis of the energizing/deenergizing signal output from the control unit 504. In this case, air introduced from the air aspiration port 104 is supplied to the second air-compressing mechanism 500b via the first air tank 516a, the directional control valve 514, and the fourth changeover passage 518d. Compressed air, which is compressed by the second air-compressing mechanism 500b, is discharged from the air supply port 102 via the second changeover passage 518b, the directional control valve 514, and the second air tank 516b.

Respective pressures of the air contained in the first air tank 516a and the second air tank 516b are detected by the first and second pressure sensors 520a, 520b, and detection signals therefrom are introduced into the control unit 504. Of course, it is also allowable that only the first air-compressing mechanism 500a is operated alone, by cutting off connection to the second electromagnetic clutch 512b in contrast to the arrangement shown in FIG. 15.

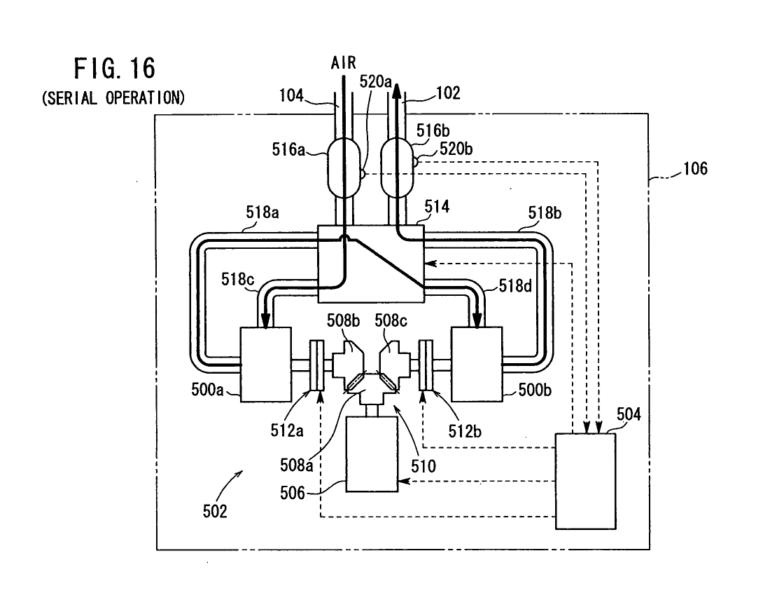

FIG. 16 shows a serial operational state, in which air introduced from the air aspiration port 104 is compressed in two stages using the first and second air-compressing mechanisms 500a, 500b. In this case, air introduced from the air aspiration port 104 is initially supplied to the first air-compressing mechanism 500a via the directional control valve 514 and the third changeover passage 518c, and thereafter, compressed air compressed by the first air-compressing mechanism 500a is returned to the directional control valve 514 via the first changeover passage 518a. Subsequently, compressed air is further compressed by the second air-compressing mechanism 500b. Air, compressed at the two stages as described above, is discharged from the air supply port 102.

As described above, air introduced from the air aspiration port 104 is compressed in two stages in accordance with serial operation of the first and second air-compressing mechanisms 500a, 500b. Accordingly, the compressed air pressure can be approximately twice that of its original pressure.

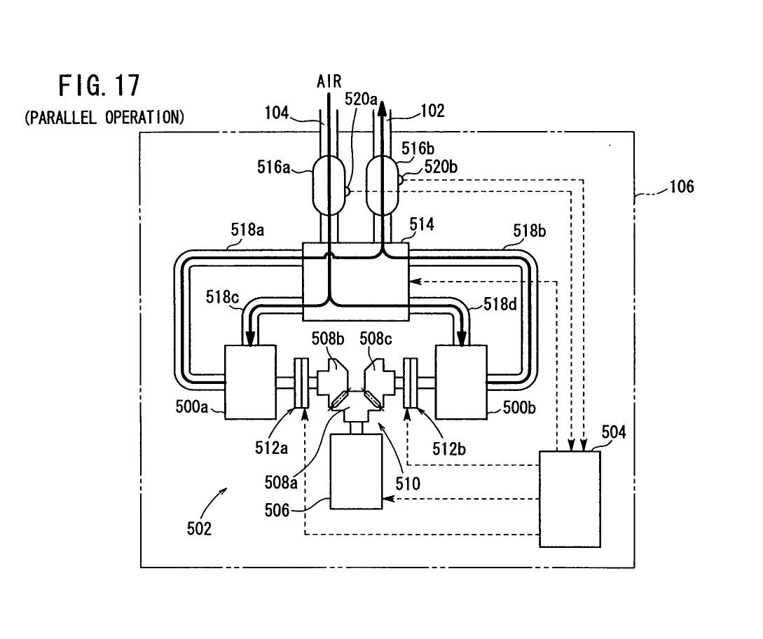

FIG. 17 shows a parallel operational state in which air introduced from the air aspiration port 104 is distributed via the first and second air-compressing mechanisms 500a, 500b. In this case, air introduced from the air aspiration port 104 is supplied to both the first air-compressing mechanism 500a and the second air-compressing mechanism 500b via the directional control valve 514. Compressed air output from the first and second air-compressing mechanisms 500a, 500b is returned and merged in the directional control valve 514 respectively, whereupon air is discharged from the air supply port 102.

As described above, the flow rate of compressed air discharged from the air supply port 102 can be approximately twice the original flow rate, by individually and simultaneously operating the first and second air-compressing mechanisms 500a, 500b and through parallel operation of the first and second air-compressing mechanisms 500a, 500b.

As described above, the compressor 106 can arbitrarily provide switching and control operations to enable a single operational state, a serial operational state, or a parallel operational state, as shown in FIGS. 15 to 17, through control of the switching signal from the control unit 504 to the directional control valve 514, the energizing/deenergizing signal supplied to the first electromagnetic clutch 512a and/or the second electromagnetic clutch 512b, and the control signal supplied to the servo motor 506, corresponding to the state of air consumption.

While the invention has been particularly shown and described with reference to preferred embodiments, it will be understood that variations and modifications can be effected thereto by those skilled in the art without departing from the spirit and scope of the invention as defined by appended claims.

1. A fluid circuit system comprising a closed loop circuit including a passage for introducing a return gas after completion of work of driving an external apparatus, into an air aspiration port of a compressor, wherein
said closed loop circuit is provided with a heat exchange mechanism which exchanges heat between a supply gas supplied to said external apparatus, said supply gas having a high temperature brought about by compression performed by said compressor, and said return gas having a low temperature.

2. The fluid circuit system according to claim 1, wherein said heat exchange mechanism comprises a heat exchange unit, said heat exchange unit including a high temperature air supply port connected to an air supply port of said compressor, a first connecting port connected to said external apparatus, a low temperature air supply port connected to a discharge port of said external apparatus via a first circulating passage, and a second connecting port connected to said air aspiration port of said compressor via a second circulating passage.

3. The fluid circuit system according to claim 2, further comprising a first communication passage that communicates between said high temperature air supply port and said first connecting port, and a second communication passage that communicates between said low temperature air supply port and said second connecting port.

4. The fluid circuit system according to claim 1, wherein said heat exchange mechanism includes a fan for feeding air.

5. The fluid circuit system according to claim 2, further comprising a pressure supply mechanism connected to said second circulating passage.

6. The fluid circuit system according to claim 5, wherein said pressure supply mechanism includes a shuttle valve connected to said second connecting port of said heat exchange unit, a regulator which reduces a pressure of replenishing compressed air supplied to said shuttle valve to a predetermined pressure, and an exhaust air recovery tank arranged between said shuttle valve and said compressor.

7. The fluid circuit system according to claim 6, wherein a compressed air supply line as a separate line, which is connected to another compressed air supply source, is connected to said regulator.

8. The fluid circuit system according to claim 1, wherein heat is transmitted from said high temperature supply gas to said low temperature return gas via oil.

9. The fluid circuit system according to claim 1, wherein said heat exchange mechanism includes heat exchange piping immersed in cooling oil accommodated in an oil chamber.

10. The fluid circuit system according to claim 9, wherein said heat exchange piping is arranged between an air cleaner that communicates with an aspiration port for aspirating exhaust air of said external apparatus, and an aspiration volume-adjusting valve that communicates with said compressor.

11. The fluid circuit system according to claim 9, wherein plural fins are provided on an outer circumferential surface of said heat exchange piping.

12. The fluid circuit system according to claim 1, wherein said heat exchange mechanism includes a double tube having an inner tube and an outer tube, and heat is exchanged in accordance with a difference in temperature between an inner tube passage and an outer tube passage.

13. The fluid circuit system according to claim 12, wherein said heat exchange mechanism includes a manifold frame, said manifold frame is provided with a first chamber, into which high temperature compressed air flowing along said inner tube passage is introduced, and a second chamber, into which low temperature exhaust air flowing along said outer tube passage is supplied, said manifold frame is provided with a partition wall which separately constitutes said first chamber and said second chamber, and heat is exchanged between said first chamber and said second chamber by the aid of heat release fins formed on said partition wall.

14. The fluid circuit system according to claim 1, wherein said compressor is capable of being switched and controlled to provide any one of a single operational state, a serial operational state, and a parallel operational state.
